(19) United States
(12) Patent Application Publication
(10) Pub. No.: US 2023/0166289 A1
(43) Pub. Date: Jun. 1, 2023

(54) MANUFACTURING METHOD FOR OPTICALLY ANISOTROPIC FILM

(71) Applicant: FUJIFILM Corporation, Tokyo (JP)

(72) Inventors: Takao TAGUCHI, Kanagawa (JP); Yuki OI, Kanagawa (JP)

(73) Assignee: FUJIFILM Corporation, Tokyo (JP)

(21) Appl. No.: 18/159,540

(22) Filed: Jan. 25, 2023

Related U.S. Application Data
(63) Continuation of application No. PCT/JP2021/027724, filed on Jul. 27, 2021.

(30) Foreign Application Priority Data
Jul. 28, 2020 (JP) 2020-127185
Jul. 26, 2021 (JP) 2021-121186

(51) Int. Cl. B05D 3/00; C09K 19/56; C09K 19/38; G02B 5/30; B05D 3/06

(52) U.S. Cl. CPC B05D 3/207; B05D 3/065; C09K 19/56; C09K 19/3852; C09K 19/3861; G02B 5/3016

(57) ABSTRACT

Provided is a manufacturing method for an optically anisotropic film in which a tilt angle of a liquid crystal compound is controlled to be constant in a thickness direction. The method includes, in the following order, steps of applying a photo-alignment composition onto a base material to form a photo-alignment composition layer, irradiating a surface of the photo-alignment composition layer with a non-polarized and collimated ultraviolet ray in an oblique direction, applying the liquid crystal composition onto the photo-alignment composition layer irradiated with the ultraviolet ray to form a liquid crystal composition layer, a applying a magnetic field to the liquid crystal composition layer along a direction substantially parallel to an irradiation direction of the ultraviolet ray in irradiating step at a temperature at which the liquid crystal composition in the liquid crystal composition layer exhibits an alignment state, and curing the liquid crystal composition layer.

### CROSS-REFERENCE TO RELATED APPLICATIONS

This application is a Continuation of PCT International Application No. PCT/JP2021/027724 filed on Jul. 27, 2021, which claims priority under 35 U.S.C. § 119(a) to Japanese Patent Application No. 2020-127185 filed on Jul. 28, 2020 and Japanese Patent Application No. 2021-121186 filed on Jul. 26, 2021. The above applications are hereby expressly incorporated by reference, in its entirety, into the present application.

### BACKGROUND OF THE INVENTION

### 1. Field of the Invention

The present invention relates to a manufacturing method for an optically anisotropic film having a uniform tilt alignment in the thickness direction.

### 2. Description of the Related Art

Use applications of optically anisotropic films formed of a liquid crystal compound have expanded in recent years not only as an image display device, such as an optical compensation sheet or a phase difference film but also as an optical member for a communication device, a camera, or an AR/VR.

In such a field, the increase in the thickness of an optically anisotropic film has progressed, and an alignment control technique using a magnetic field has been studied in addition to the liquid crystal alignment control in the related art by a rubbing treatment or a photo-alignment treatment.

For example, JP4378910B discloses a manufacturing method for an optically anisotropic film in which an optical axis of a liquid crystal compound is tilted using a magnetic field.

### SUMMARY OF THE INVENTION

As a result of studying the manufacturing method disclosed in JP4378910B, the inventors of the present invention revealed there is a problem that the tilt control of the liquid crystal compound in the vicinity of the base material interface is insufficient and the tilt angle continuously changes along the thickness direction.

Therefore, an object of the present invention is to provide a manufacturing method for an optically anisotropic film in which a tilt angle of a liquid crystal compound is controlled to be constant in a thickness direction.

As a result of diligent studies to achieve the above object, the inventors of the present invention found that in a case of combining an alignment control by a photo-alignment film and an alignment control by application of a magnetic field, the tilt angle of the liquid crystal compound can be made uniform in the thickness direction of the optically anisotropic film, whereby the present invention was completed.

That is, it was found that the object described above can be achieved by the following configurations.

(1) A manufacturing method for an optically anisotropic film using a liquid crystal composition containing a polymerizable liquid crystal compound having magnetic field responsiveness, the manufacturing method comprising, in the following order:
a step 1 of applying a photo-alignment composition onto a base material to form a photo-alignment composition layer;
a step 2 of irradiating a surface of the photo-alignment composition layer with a non-polarized and collimated ultraviolet ray in an oblique direction;
a step 3 of applying the liquid crystal composition onto the photo-alignment composition layer irradiated with the ultraviolet ray to form a liquid crystal composition layer;
a step 4 of applying a magnetic field to the liquid crystal composition layer along a direction substantially parallel to an irradiation direction of the ultraviolet ray in the step 2 at a temperature at which the liquid crystal composition in the liquid crystal composition layer exhibits an alignment state; and
a step 5 of curing the liquid crystal composition layer.

The manufacturing method for an optically anisotropic film according to (1), in which in the step 2, the irradiation direction of the ultraviolet ray is 5° to 85° with respect to a normal direction of the surface of the photo-alignment composition layer.

The manufacturing method for an optically anisotropic film according to (1) or (2), in which the polymerizable liquid crystal compound is a rod-like liquid crystal compound having three or more benzene rings.

The manufacturing method for an optically anisotropic film according to any one of (1) to (3), in which in the step 4, a magnetic flux density of the magnetic field is 0.2 to 1.0 T.

According to the present invention, it is possible to provide a manufacturing method for an optically anisotropic film in which a tilt angle of a liquid crystal compound is controlled to be constant in a thickness direction.

### BRIEF DESCRIPTION OF THE DRAWINGS

FIG. 1 is a view for describing a step 1.

FIG. 2 is a view for describing a step 2.

FIG. 3 is a view for describing a step 3.

FIG. 4 is a view for describing a step 4.

FIG. 5 is a view for describing a cross-sectional section.

FIG. 6 is a view for describing a region of the cross-sectional section.

### DESCRIPTION OF THE PREFERRED EMBODIMENTS

Hereinafter, the present invention will be described in detail.

In the present specification, the numerical range indicated by using “to” means a range including numerical values described before and after “to” as a minimum value and a maximum value, respectively.

In the range of numerical values disclosed stepwise in the present specification, an upper limit value or a lower limit value disclosed in a certain range of numerical values may be replaced with an upper limit value or a lower limit value disclosed in another range of numerical values disclosed in stepwise. In addition, in the range of numerical values disclosed in the specification, an upper limit value or a lower limit value disclosed in a certain range of numerical values may be replaced with values shown in examples.

In the present specification, in a case where there are a plurality of substances corresponding to each component in the composition, the amount of each component in the composition means the total amount of the plurality of substances present in the composition unless otherwise particularly specified.

In the present specification, a combination of two or more preferred aspects is a more preferred aspect.

In the present specification, the term “step” includes not only an independent step but also a step that cannot be clearly distinguished from other steps, as long as the intended purpose of the step is achieved.

Hereinafter, a manufacturing method of the present disclosure will be described in detail.

The manufacturing method for an optically anisotropic film according to the embodiment of the present invention includes the following steps 1 to 5 in the following order.
Step 1: A step of applying a photo-alignment composition onto a base material to form a photo-alignment composition layer
Step 2: A step of irradiating a surface of the photo-alignment composition layer with a non-polarized and collimated ultraviolet ray in an oblique direction
Step 3: A step of applying a liquid crystal composition containing a polymerizable liquid crystal compound having magnetic field responsiveness onto the photo-alignment composition layer irradiated with the ultraviolet ray to form a liquid crystal composition layer
Step 4: A step of applying a magnetic field to the liquid crystal composition layer along a direction substantially parallel to an irradiation direction of the ultraviolet ray in the step 2 at a temperature at which the liquid crystal composition in the liquid crystal composition layer exhibits an alignment state
Step 5: A step of curing the liquid crystal composition layer

Hereinafter, each step will be described with reference to the drawings.

### Step 1

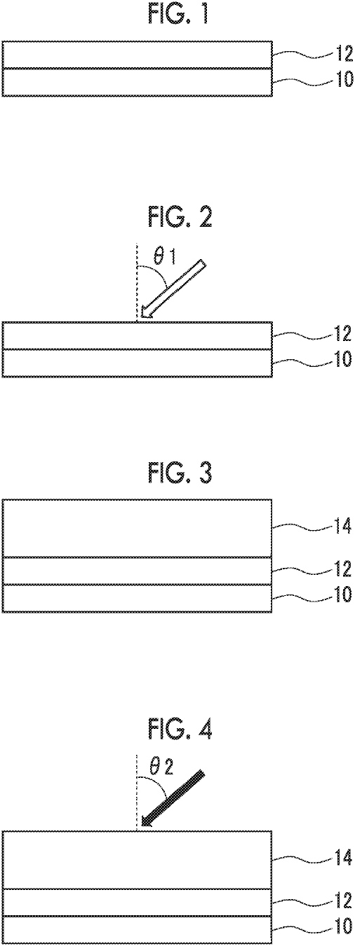

The step 1 is step of applying a photo-alignment composition onto a base material to form a photo-alignment composition layer. By carrying out the step 1, a photo-alignment composition layer 12 is disposed on a base material 10 as illustrated in FIG. 1.

Hereinafter, first, a material that is used in the step 1 will be described in detail, and then the procedure of the step will be described in detail.

### Base Material

The kind of base material is not particularly limited as long as the base material is a member that supports a photo-alignment composition layer, and examples the base material include a glass plate, a quartz plate, and a polymer film, where a glass plate is preferable.

The thickness of the base material is not particularly limited; however, it is preferably 0.1 to 4 mm and more preferably 0.5 to 2 mm.

### Photo-Alignment Composition

The photo-alignment composition contains a photo-alignment compound.

The photo-alignment compound is a compound having a photo-alignable group.

The photo-alignable group is a functional group capable of imparting anisotropy to a film by irradiation with light. More specifically, the photo-alignable group is a group in which the molecular structure therein can be changed by irradiation with light (for example, linearly polarized light). Typically, the photo-alignable group refers to a group that undergoes at least one photo-reaction selected from a photo-isomerization reaction, a photo-dimerization reaction, or a photodegradation reaction by irradiation with light (for example, linearly polarized light).

Among these photo-alignable groups, a group (a group having a photo-isomerization structure that becomes photo-isomerized) that undergoes a photo-isomerization reaction or a group (a group having a structure that becomes photo-dimerized) that undergoes a photo-dimerization reaction is preferable, and a group that undergoes a photo dimerization reaction occurs is more preferable.

The group that undergoes a photo-isomerization reaction is preferably a group that undergoes a photo-isomerization reaction including a C═C bond or an N═N bond is preferable, and examples of such a group include a group having an azobenzene structure (skeleton), a group having a hydrazone-β-ketoester structure (skeleton), a group having a stilbene structure (skeleton), and a group having a spiropyran structure (skeleton).

Examples of the group that undergoes a photo-dimerization reaction include a group having a cinnamic acid (cinnamoyl) structure (skeleton), a group having a coumarin structure (skeleton), a group having a chalcone structure (skeleton), a group having a benzophenone structure (skeleton), and a group having anthracene structure (skeleton).

Examples the photo-alignment compound include azo compounds described in JP2006-285197A, JP2007-076839A, JP2007-138138A, JP2007-094071A, JP2007-121721A, JP2007-140465A, JP2007-156439A, JP2007-133184A, JP2009-109831A, JP3883848B, and JP4151746B, aromatic ester compounds described in JP2002-229039A, maleimide and/or alkenyl-substituted nadimide compounds having photo-alignable units described in JP2002-265541A and JP2002-317013A, photo-crosslinkable silane derivatives described in JP4205195B and JP4205198B, photo-crosslinkable polyimides, photo-crosslinkable polyamides, and photo-crosslinkable esters described in JP2003-520878A, JP2004-529220A, and JP4162850B, and photo-dimerizable compounds described in JP1997-118717A (JP-H9-118717A), JP1998-506420A (JP-H10-506420A), JP-2003-505561A, WO2010/150748A, JP2013-177561A, and JP2014-012823A. In particular, preferred examples thereof include a cinnamate compound, a chalcone compound, and a coumarin compound.

Among them, an azo compound, a photo-crosslinkable polyimide, a photo-crosslinkable polyamide, a photo-crosslinkable polyester, a cinnamate compound, or a chalcone compound is suitably used.

The photo-alignment composition preferably contains a solvent.

Examples of the solvent include water and an organic solvent.

Examples of the organic solvent include ketones, ethers, aliphatic hydrocarbons, alicyclic hydrocarbons, aromatic hydrocarbons, carbon halides, esters, alcohols, cellosolves, cellosolve acetates, sulfoxides, and amides. These may be used alone or, two or more kinds thereof may be used in combination.

The photo-alignment composition may contain another component other than the above, and examples thereof include an adhesion improver, a leveling agent, a surfactant, and a plasticizer.

### Procedure of Step 1

In the step 1, the method of applying the photo-alignment composition onto a base material is not particularly limited.

Examples of the coating method include spin coating, die coating, gravure coating, flexo printing, and inkjet printing.

After the photo-alignment composition is applied onto the base material, a drying treatment may be carried out, as necessary.

Examples of the drying treatment include a heating treatment. The conditions for the heating treatment are not particularly limited; however, the heating temperature is preferably 30° C. to 100° C., and the heating time is preferably 10 to 600 seconds.

According to the above procedure, the photo-alignment composition layer is formed on the base material.

The thickness of the photo-alignment composition layer is not limited, and a thickness at which a required alignment function can be obtained may be appropriately set depending on the photo-alignment compound.

The thickness of the photo-alignment composition layer is preferably 0.01 to 5 µm and more preferably 0.05 to 2 µm.

### Step 2

The step 2 is a step of irradiating a surface of the photo-alignment composition layer with a non-polarized and collimated ultraviolet ray in an oblique direction. As illustrated in FIG. 2, the surface of the photo-alignment composition layer 12 is irradiated with a non-polarized and collimated ultraviolet ray in an oblique direction as indicated by a white arrow. As illustrated in FIG. 2, it is noted that the oblique direction is intended to be a direction tilted by the θ1 degree with respect to the normal direction of the surface of the photo-alignment composition layer 12.

By carrying out the step 2 described above, an alignment restriction force is applied to the surface of the photo-alignment composition layer. That is, a photo-alignment composition layer that can regulate the alignment direction of the liquid crystal compound disposed on the surface thereof is formed.

Hereinafter, the procedure of the step 2 will be described in detail.

As described above, in the step 2, the photo-alignment composition layer is irradiated with predetermined ultraviolet rays in an oblique direction.

As described above, the “oblique direction” is not particularly limited as long as it is a direction tilted by a polar angle θ1 (0 < θ < 90°) with respect to the normal direction of the surface of the photo-alignment composition layer, and it can be appropriately selected according to the intended purpose.

Among the above, the irradiation direction of the ultraviolet ray is preferably 5° to 85° and more preferably 20° to 80° with respect to the normal direction of the surface of the photo-alignment composition layer. That is, θ1 in FIG. 2 is preferably 5° to 85° and more preferably 20° to 80°.

The photo-alignment composition layer is irradiated with a non-polarized and collimated ultraviolet ray.

Examples of the ultraviolet ray include light having a wavelength of 10 to 400 nm.

The non-polarized light is random light in which a specific dominant polarized state is not observed.

The collimated light is a concept that includes not only completely parallel light but also substantially parallel light (for example, some condensed light and diverging light). More specifically, the parallelism of the collimated light is preferably within ±15°, more preferably within ±10°, and still more preferably within ±5°.

Examples of the light source for irradiating the ultraviolet ray include a xenon lamp, a high pressure mercury lamp, an ultra-high pressure mercury lamp, and a metal halide lamp. In a case where an interference filter, a color filter, or the like is used for filtering the light obtained from such a light source, the wavelength range for irradiation can be limited.

Further, by using a collimating lens or a louver with respect to the light from these light sources, the collimated light can be obtained.

The integrated light amount of ultraviolet rays is not particularly limited as long as the ability to control the alignment of liquid crystal molecules is imparted to the photo-alignment composition layer, and it is preferably 10 to 3,000 mJ/cm² and more preferably 500 to 2,000 mJ/cm².

The illuminance of ultraviolet rays is not particularly limited as long as the ability to control the alignment of liquid crystal molecules is imparted to the photo-alignment composition, and is preferably 1 to 300 mW/cm² and more preferably 5 to 100 mW/cm².

### Step 3

The step 3 is a step of applying a liquid crystal composition containing a polymerizable liquid crystal compound having magnetic field responsiveness onto the photo-alignment composition layer irradiated with the ultraviolet ray to form a liquid crystal composition layer. By carrying out the step 3, a laminate including the base material 10, the photo-alignment composition layer 12, and a liquid crystal composition layer 14 is formed.

Hereinafter, first, a material that is used in the step 3 will be described in detail, and then the procedure of the step will be described in detail.

### Liquid Crystal Composition

The liquid crystal composition includes a polymerizable liquid crystal compound having magnetic field responsiveness.

The polymerizable liquid crystal compound having magnetic field responsiveness is a polymerizable liquid crystal compound in which the alignment direction changes in response to a magnetic field applied in a step 4 described later in accordance with the magnetic field. More specifically, in a case where the polymerizable liquid crystal compound has a mesogen group including a plurality of aromatic ring structures, it is excellent in magnetic field responsiveness. It is noted that the mesogenic group is a group indicating the main skeleton of liquid crystal molecules contributing to the formation of the liquid crystal.

The aromatic ring structure may be a monocyclic aromatic ring structure or may be a polycyclic aromatic ring structure. Examples of the aromatic ring structure include a benzene ring structure and a naphthalene ring structure. The plurality of aromatic ring structures contained in the mesogen group may be directly bonded to each other or may be bonded through a divalent linking group (for example, —CO—, —O—, —NR— (R represents a hydrogen atom or an alkyl group), or a divalent aliphatic group) other than the aromatic ring structure.

The polymerizable liquid crystal compound having magnetic field responsiveness preferably has a mesogen group represented by Formula (X).

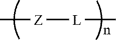

Z represents a divalent aromatic ring group or a divalent aliphatic ring group.
L represents a single bond or a divalent linking group other than the divalent aromatic ring group and the divalent aliphatic ring group.
n represents an integer of 2 or more.
However, the mesogen group represented by Formula (X) contains two or more divalent aromatic ring groups.

The divalent aromatic ring group may have a monocyclic structure or a polycyclic structure.

Examples of the divalent aromatic ring group include a phenylene group.

A non-aromatic ring may be fused to the divalent aromatic ring group. For example, a non-aromatic ring containing a heteroatom may be fused to the phenylene group.

Examples of the divalent aliphatic ring group include a cyclohexylene group.

Examples of the divalent linking group other than the divalent aromatic ring group represented by L and the divalent aliphatic ring group include —COO—, —CO—, —O—, —S—, —CONR¹—, —SO₂—, and —NR²—. R¹ and R² each independently represent a hydrogen atom or an alkyl group.

n represents an integer of 2 or more, where an integer of 2 to 5 is preferable, and an integer of 2 to 4 is more preferable.

The polymerizable liquid crystal compound having magnetic field responsiveness has a polymerizable group.

The kind of the polymerizable group is not particularly limited, and examples thereof include an unsaturated polymerizable group, an epoxy group, and an aziridinyl group, where an unsaturated polymerizable group is preferable, an ethylenically unsaturated polymerizable group is more preferable, and an acryloyl group or a methacryloyl group is still more preferable.

The polymerizable group can be introduced into the molecule of the liquid crystal compound by various methods.

The number of polymerizable groups contained in the polymerizable liquid crystal compound is preferably 1 to 6 and more preferably 1 to 3.

The polymerizable liquid crystal compound having magnetic field responsiveness is preferably a compound represented by Formula (Y).

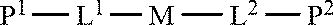

P¹ and P² each independently represent a polymerizable group. The definition of the polymerizable group is as described above.
L¹ and L² each independently represent a divalent linking group. Examples of the divalent linking group include divalent hydrocarbon groups (for example, divalent aliphatic hydrocarbon groups such as an alkylene group having 1 to 10 carbon atoms, an alkenylene group having 1 to 10 carbon atoms, and an alkynylene group having 1 to 10 carbon atoms, and a divalent aromatic hydrocarbon group such as an arylene group), a divalent heterocyclic group, —O—, —S—, —NH—, —N(Q)—, —CO—, or groups obtained by combining these (for example, an —O—divalent hydrocarbon group-, an —(O—divalent hydrocarbon group)ₘ—O— (m represents an integer of 1 or more), and a -divalent hydrocarbon group—O—CO—). Q represents a hydrogen atom or an alkyl group.
M represents a mesogen group represented by Formula (X).

The polymerizable liquid crystal compound having magnetic field responsiveness is preferably a rod-like polymerizable liquid crystal compound. Among the above, a rod-like liquid crystal compound having three or more benzene rings is more preferable.

Examples of the rod-like polymerizable liquid crystal compound include a rod-like nematic liquid crystal compound. Preferable examples of the rod-like nematic liquid crystal compounds include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolans, and alkenylcyclohexylbenzonitriles.

Not only a low-molecular-weight liquid crystal compound but also a polymer liquid crystal compound can be used.

Examples of the polymerizable liquid crystal compound include compounds disclosed in Makromol. Chem., Vol. 190, page 2255 (1989), Advanced Materials, Vol. 5, page 107 (1993), US4683327A, US5622648A, US5770107A, WO95/022586A, WO95/024455A, WO97/00600A, WO98/023580A, WO98/052905A, JP1989-272551A (JP-H1-272551A), JP1994-016616A (JP-H6-016616A), JP1995-110469A (JP-H7-110469A), JP1999-080081A (JP-H11-080081A), and JP2001-328973A.

Two or more kinds of polymerizable liquid crystal compounds may be used in combination. In a case of using two or more kinds of polymerizable liquid crystal compounds in combination, it is possible to decrease the alignment temperature.

The liquid crystal composition may contain a solvent.

Examples of the solvent include water and an organic solvent.

Examples of the organic solvent include the solvents exemplified as the organic solvent which may be contained in the above-described photo-alignment composition.

The liquid crystal composition may contain another component other than the above, and examples thereof include an adhesion improver, a leveling agent, a surfactant, and a plasticizer.

### Procedure of Step 3

In the step 3, the method of applying the liquid crystal composition onto the photo-alignment composition layer is not particularly limited.

Examples of the coating method include spin coating, die coating, gravure coating, flexo printing, and inkjet printing.

After the liquid crystal composition is applied onto the photo-alignment composition layer, a drying treatment may be carried out, as necessary.

Examples of the drying treatment include a heating treatment. The conditions for the heating treatment are not particularly limited; however, the heating temperature is preferably 30° C. to 150° C., and the heating time is preferably 10 to 600 seconds.

A liquid crystal composition layer is formed on the photo-alignment composition layer according to the above procedure.

The thickness of the liquid crystal composition layer is not limited, and a thickness at which a required alignment function can be obtained may be appropriately set depending on the kind of the polymerizable liquid crystal compound.

The thickness of the photo-alignment composition layer is preferably 5 to 100 µm and more preferably 20 to 50 µm.

After the step 3 and before the step 4 described later, a step of subj ecting the liquid crystal composition layer to a heating treatment to align the liquid crystal compound in the liquid crystal composition layer may be carried out.

Examples of the temperature of the heating treatment include a temperature at which the liquid crystal composition in the liquid crystal composition layer exhibits an alignment state.

### Step 4

The step 4 is a step of applying a magnetic field to the liquid crystal composition layer along a direction substantially parallel to an irradiation direction of the ultraviolet ray in the step 2 at a temperature at which the liquid crystal composition in the liquid crystal composition layer exhibits an alignment state. In the step 4, as shown by the black arrow in FIG. 4, a magnetic field is applied to the liquid crystal composition layer 14 along a direction substantially parallel to an irradiation direction of the ultraviolet ray in the step 2. As illustrated in FIG. 4, the application direction of the magnetic field is a direction tilted by the θ2 degree with respect to the normal direction of the surface of the liquid crystal composition layer 14, and the θ2 degree shown in FIG. 4 indicates the same angle as the θ1 degree shown in FIG. 2.

Hereinafter, the procedure of the step 4 will be described in detail.

The step 4 is carried out at a temperature at which the liquid crystal composition in the liquid crystal composition layer exhibits an alignment state. That is, the step 4 is carried out in a temperature range in which the liquid crystal composition in the liquid crystal composition layer exhibits a liquid crystal phase.

The temperature is preferably a temperature equal to or higher than the liquid crystal transition temperature of the polymerizable liquid crystal compound contained in the liquid crystal composition layer.

The direction in which the magnetic field is applied is substantially parallel to the irradiation direction of the ultraviolet ray in the step 2. The term “substantially parallel” means that an angle formed by the direction in which the magnetic field is applied and the irradiation direction of the ultraviolet ray is within 7°, where an angle within 3° is preferable.

The magnetic flux density of the magnetic field is preferably 0.1 T or more, more preferably 0.2 T or more, and still more preferably 0.4 T or more. From the viewpoint of productivity, the upper limit is preferably 2.0 T or less and more preferably 1.0 T or less.

The application time of the magnetic field is not particularly limited. It is preferably 10 minutes or less and more preferably 1 minute or less from the viewpoint of productivity.

The method of applying the magnetic field is not particularly limited, and examples thereof include a method using a permanent magnet or an electromagnet.

It is noted that a plurality of magnets may be used to simultaneously apply a magnetic field to the entire liquid crystal composition layer having a large area. In addition, a base material on which the liquid crystal composition layer is laminated within a region where a magnetic field is generated in a constant direction may be transported to apply a magnetic field thereto.

After the step 4, a step of decreasing the temperature from a temperature at which the liquid crystal composition in the liquid crystal composition layer is in an alignment state may be carried out while applying a magnetic field to the liquid crystal composition layer. In a case of carrying out the above-described step, the temperature of the liquid crystal composition layer is decreased to a temperature lower than the temperature at which the liquid crystal composition exhibits an alignment state.

The temperature of the liquid crystal composition layer is preferably decreased to room temperature (25° C.).

### Step 5

The step 5 is a step of curing the liquid crystal composition layer obtained in the step 4.

The method for the curing treatment is not particularly limited, and examples thereof include a light irradiation treatment and a heating treatment. Among them, a light irradiation treatment is preferable, and an ultraviolet irradiation treatment is more preferable from the viewpoint of manufacturing suitability.

The irradiation conditions of the light irradiation treatment are not particularly limited; however, an irradiation amount of 50 to 1,000 mJ/cm² is preferable.

It is preferable that light irradiation is carried out under the condition of room temperature (25° C.).

In addition, in a case of carrying out the light irradiation treatment, the light irradiation may be carried out at one time, or the light irradiation may be carried out stepwise by changing the illuminance. In a case where the irradiation is carried out stepwise by changing the illuminance, it is preferable to carry out the light irradiation stepwise while increasing the illuminance. For example, after carrying out the first light irradiation with an illuminance of 20 mW/cm² or less (preferably 15 mW/cm² or less), the second light irradiation may be carried out with an illuminance of more than 20 mW/cm² (preferably 50 mW/cm² or more).

In a case of carrying out the above-described steps, an optically anisotropic film in which the tilt angle of the liquid crystal compound is controlled to be constant in the thickness direction is manufactured.

The thickness of the optically anisotropic film is not particularly limited, and it is preferably 5 to 100 µm and more preferably 20 to 50 µm.

The front phase difference of the optically anisotropic film at a wavelength of 550 nm is not limited, and the phase difference at which the required alignment function can be obtained may be appropriately set.

The front phase difference at a wavelength of 550 nm is preferably 1,000 to 10,000 nm and more preferably 3,000 to 6,000 nm.

Although it is preferable that a backward dispersibility is provided, a phase difference plate having a small wavelength dispersibility of the phase difference or a liquid crystal curing film having a forward dispersibility can also be used. The backward dispersibility means a property that the absolute value of the phase difference increases as the wavelength becomes longer, and the forward dispersibility means a property that the absolute value of the phase difference increases as the wavelength becomes shorter.

### Use Application

The optically anisotropic film produced by the manufacturing method according to the embodiment of the present invention can be used as a discoloration film for an image display device, a beam splitter for a laser light source, a low-pass filter for imaging, and the like. Examples

Hereinafter, the present disclosure will be described further specifically with reference to Examples. However, the present disclosure is not limited to the following Examples as long as the gist of the present invention is not exceeded.

### Example 1

### Formation of Photo-Alignment Composition Layer (Step 1)

A glass plate was prepared as a support. The following photo-alignment composition was applied onto the support by spin coating to form a photo-alignment composition layer. The support on which the photo-alignment composition layer was formed was dried on a hot plate at 60° C. for 60 seconds.

Photo-Alignment Composition

| | |
|---|---|
| Photo-alignment compound below | 1.00 parts by mass |
| Water | 16.00 parts by mass |
| Butoxyethanol | 42.00 parts by mass |
| Propylene glycol monomethyl ether | 42.00 parts by mass |

Photo-Alignment Compound

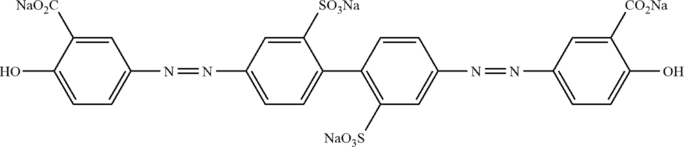

### Exposure of Photo-Alignment Composition Layer (Step 2)

The obtained photo-alignment composition layer was irradiated with unpolarized ultraviolet rays collimated at an angle of 45° with respect to the normal direction of the film surface (2,000 mJ/cm², using an ultra-high pressure mercury lamp, using a collimating lens), to subject the photo-alignment composition layer to exposure.

### Formation of Liquid Crystal Composition Layer (Step 3)

The following liquid crystal composition A-1 was prepared as the liquid crystal composition. The liquid crystal composition A-1 is a liquid crystal composition that forms a nematic liquid crystal.

Liquid Crystal Composition A-1

| | |
|---|---|
| Rod-like liquid crystal compound L-1 below | 100.00 parts by mass |
| Polymerization initiator (Omnirad 819, manufactured by BASF SE) | 4.00 parts by mass |
| Highsolve MTEM (manufactured by TOHO Chemical Industry Co., Ltd.) | 1.00 parts by mass |
| Cyclopentanone | 171.12 parts by mass |

Rod-Like Liquid Crystal Compound L-1 (a mixture of the following compounds, any one of the compounds corresponds to a polymerizable liquid crystal compound having magnetic field responsiveness)

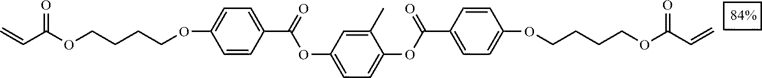

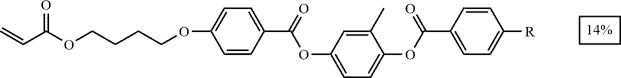

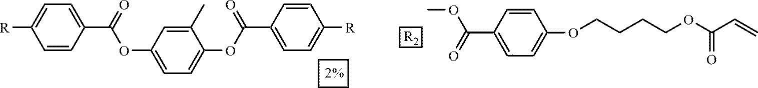

The above-described liquid crystal composition A-1 was applied onto the exposed photo-alignment composition layer, the obtained coating film was heated to 110° C. on a hot plate, and the solvent was dried to obtain a liquid crystal composition layer. Then, a magnetic field (0.6 T) was applied from a direction of 45° with respect to the normal direction of the liquid crystal composition layer by using an electromagnet while maintaining the temperature at 110° C. with hot air.

It is noted that the above 110° C. was a temperature at which the liquid crystal composition in the liquid crystal composition exhibited a liquid crystal phase. In addition, the direction in which the magnetic field is applied is parallel to the irradiation direction of the ultraviolet ray.

The liquid crystal compound was cooled to 25° C. in a state where a magnetic field was applied and then subjected to ultraviolet irradiation (100 mJ/cm², LED-UV wavelength: 365 nm) at an illuminance of 10 mW/cm² in an air atmosphere to fix the alignment of the liquid crystal compound. Further, ultraviolet irradiation was carried out in a nitrogen atmosphere at an illuminance of 100 mW/cm² (300 mJ/cm², LED-UV wavelength: 365 nm) to complete the polymerization, thereby obtaining an optically anisotropic film.

The film thickness of the obtained optically anisotropic film was 31.1 µm. Further, the retardation measurement values at a wavelength of 550 nm at incident angles -45°, 0°, and 45° (on a plane including the magnetic field application direction), obtained by using an AxoScan manufactured by Axometricx, Inc., were 850 nm, 2550 nm, and 5200 nm, respectively. It was confirmed that the liquid crystal molecules were tilt-aligned with respect to the film surface since the retardation at -45° and the retardation at 45° were different.

### Examples 2 to 4

Optically anisotropic films were prepared according to the same procedure as in Example 1, except that the film thickness of the liquid crystal composition layer and the magnetic flux density were changed.

### Example 5

An optically anisotropic film was prepared according to the same procedure as in Example 1, except that the following liquid crystal composition A-2 was used as the liquid crystal composition.

Liquid Crystal Composition A-2

| | |
|---|---|
| Rod-like liquid crystal compound L-2 below | 50.00 parts by mass |
| Rod-like liquid crystal compound L-3 below | 50.00 parts by mass |
| Polymerization initiator (Omnirad 819, manufactured by BASF SE) | 4.00 parts by mass |
| Highsolve MTEM (manufactured by TOHO Chemical Industry Co., Ltd.) | |
| | 1.00 parts by mass |
| Cyclopentanone | 171.12 parts by mass |

Rod-Like Liquid Crystal Compound L-2 (corresponds to the polymerizable liquid crystal compound having magnetic field responsiveness)

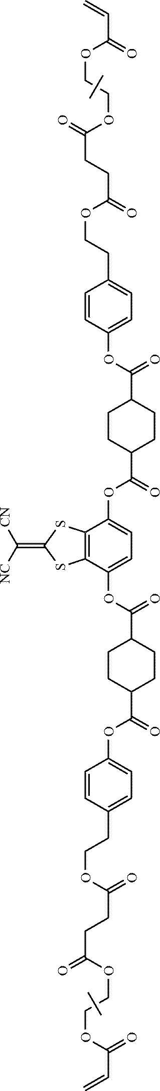

Rod-Like Liquid Crystal Compound L-3 (corresponds to the polymerizable liquid crystal compound having magnetic field responsiveness)

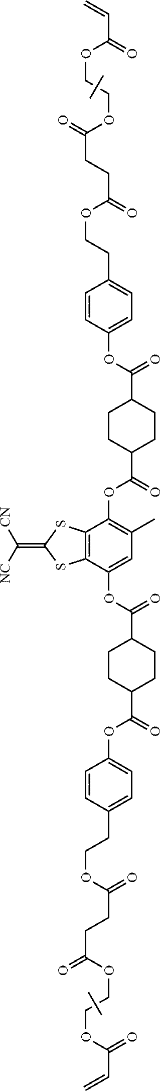

### Comparative Example 1

An optically anisotropic film was prepared according to the same procedure as in Example 1, except that the irradiation was carried out with ultraviolet rays (2,000 mJ/cm², using an ultra-high pressure mercury lamp) which was non-collimated and was polarized light.

It is noted that the direction of the magnetic field was parallel to a surface including the amplitude direction of the polarized ultraviolet rays.

### Comparative Example 2

An optically anisotropic film was prepared according to the same procedure as in Example 1 except that no magnetic field was applied during aging.

### Comparative Example 3

An optically anisotropic film was prepared according to the same procedure as in Example 1, except that the following liquid crystal composition A-3 was used as the liquid crystal composition.

Liquid Crystal Composition A-3

| | |
|---|---|
| Rod-like liquid crystal compound L-4 below | 50.00 parts by mass |
| Rod-like liquid crystal compound L-5 below | 50.00 parts by mass |
| Polymerization initiator (Omnirad 819, manufactured by BASF SE) | 4.00 parts by mass |
| Highsolve MTEM (manufactured by TOHO Chemical Industry Co., Ltd.) | |
| | 1.00 parts by mass |
| Cyclopentanone | 171.12 parts by mass |

Rod-Like Liquid Crystal Compound L-4 (does not correspond to the polymerizable liquid crystal compound having magnetic field responsiveness)

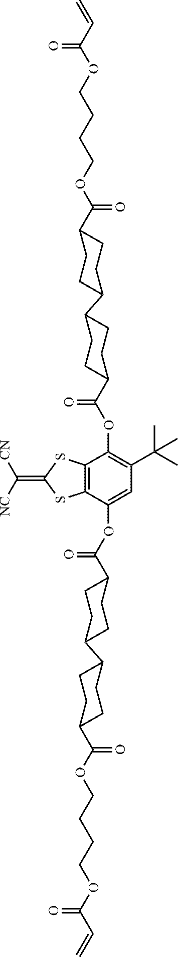

Rod-Like Liquid Crystal Compound L-5 (does not correspond to the polymerizable liquid crystal compound having magnetic field responsiveness)

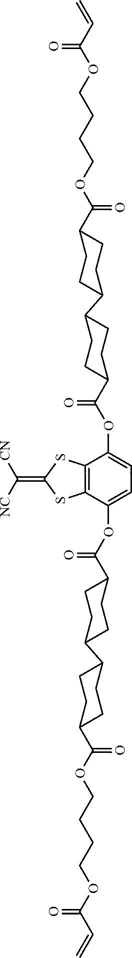

### Evaluation Method

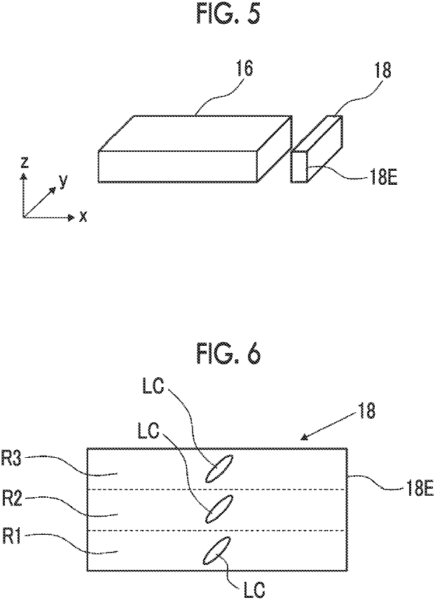

After peeling off the optically anisotropic film from the glass substrate, a cross-sectional section was prepared using a microtome, and the cross-sectional section was placed on a slide glass. At the time of preparing the cross-sectional section, the optically anisotropic film was observed from the normal direction and cut along a direction in which the liquid crystal compound was aligned to prepare the cross-sectional section. More specifically, as illustrated in FIG. 5, since the liquid crystal compound was aligned in the y direction in the optically anisotropic film 16 in a case of being observed from the normal direction, a cross-sectional section 18 was obtained by cutting along the y direction. As illustrated in FIG. 5, a side 18E of the cross-sectional section 18 corresponds to a side in the thickness direction of the optically anisotropic film 16.

The cross-sectional section prepared above was placed between two polarizing plates disposed on the crossed nicols. At this time, the side (see FIG. 5) of the cross-sectional section corresponding to the thickness direction of the optically anisotropic film was arranged to be parallel to the transmission axis of either of the polarizing plates.

Next, the slide glass was rotated using a quenching degree measuring device (manufactured by Otsuka Electronics Co., Ltd., measurement wavelength: 550 nm), and a rotation position at which quenching is carried out was confirmed. At this time, as illustrated in FIG. 6, the cross-sectional section was divided into three regions along the side 18E corresponding to the thickness direction of the optically anisotropic film of the cross-sectional section 18, and a region on a side where the photo-alignment composition layer was disposed was designated as a region R1, a region on the air interface side was designated as a region R3, and a region between them was designated as a region R2. The more uniform the tilt angle of the liquid crystal compound in the thickness direction of the optically anisotropic film, the more the alignment directions of the liquid crystal compound LC in the regions R1 to R3 are aligned. As a result, the difference in the rotation angle for quenching the light in the regions R1 to R3 is small in a case where the slide glass is rotated as described above. In a case where the liquid crystal compound is not aligned in any one of regions R1 to R3, the region is a place where the quenching does not occur.

The above measurement was carried out, and the evaluation was carried out according to the following criteria.

AA: The rotation angle for quenching in each of the three divided regions is in a range of ±2° or less.

A: The rotation angle for quenching in each of the three divided regions is in a range of more than ±2° and a range of ±5° or less.

B: The rotation angle for quenching in each of the three divided regions is wider than ±5°.

C: The quenching does not occur in at least one of the three divided regions.

The results are summarized in Table 1.

In Table 1, “Number of benzene rings” indicates the kind of the liquid crystal composition used, where the number in parentheses indicates the number of benzene rings in the liquid crystal compound used in the liquid crystal composition.

It is noted that in Examples 1 to 5, the irradiation direction of the ultraviolet ray with which the photo-alignment composition layer was irradiated and the application direction of the magnetic field were both 45° and parallel to each other.

TABLE 1

| Table 1 | Liquid crystal composition | Photo-alignment | | | Magnetic field | | | Film thickness (µm) | Determination |
|---|---|---|---|---|---|---|---|---|---|
| | Number of benzene rings | Polarized/ Non-polarized | Collimated/ Non-collimated | Irradiation angle [°] | Present/Absent | Magnetic field application direction [°] | Magnetic flux density [T] | | |
| Example 1 | A-1 (3) | Non-polarized | Collimated | 45 | Present | 45 | 0.6 | 31.1 | AA |
| Example 2 | A-1 (3) | Non-polarized | Collimated | 45 | Present | 45 | 0.2 | 10.2 | A |
| Example 3 | A-1 (3) | Non-polarized | Collimated | 45 | Present | 45 | 0.4 | 21.4 | AA |
| Example 4 | A-1 (3) | Non-polarized | Collimated | 45 | Present | 45 | 1 | 36.2 | AA |
| Example 5 | A-2 (3) | Non-polarized | Collimated | 45 | Present | 45 | 1 | 30.8 | AA |
| Comparative Example 1 | A-1 (3) | Polarized | Non-collimated | - | Present | 45 | 1 | 31.3 | B |
| Comparative Example 2 | A-1 (3) | Non-polarized | Collimated | 45 | Absent | - | - | 31.3 | C |
| Comparative Example 3 | A-3 (1) | Non-polarized | Collimated | 45 | Present | 45 | 1 | 31.2 | C |

As shown in Table 1, it has been confirmed that according to the manufacturing method according to the embodiment of the present invention, the desired effect can be obtained.

From the comparison of Examples 1 to 5, it has been confirmed that the effect is more excellent in a case where the magnetic flux density is 0.4 T or more.

### EXPLANATION OF REFERENCES

| | |
|---|---|
| 10 | base material |
| 12 | photo-alignment composition layer |
| 14 | liquid crystal composition layer |
| 16 | opically anisotropic film |
| 18 | cross-sectional section |

What is claimed is:

1. A manufacturing method for an optically anisotropic film using a liquid crystal composition containing a polymerizable liquid crystal compound having magnetic field responsiveness, the manufacturing method comprising, in the following order:
a step 1 of applying a photo-alignment composition onto a base material to form a photo-alignment composition layer;
a step 2 of irradiating a surface of the photo-alignment composition layer with a non-polarized and collimated ultraviolet ray in an oblique direction;
a step 3 of applying the liquid crystal composition onto the photo-alignment composition layer irradiated with the ultraviolet ray to form a liquid crystal composition layer;
a step 4 of applying a magnetic field to the liquid crystal composition layer along a direction substantially parallel to an irradiation direction of the ultraviolet ray in the step 2 at a temperature at which the liquid crystal composition in the liquid crystal composition layer exhibits an alignment state; and
a step 5 of curing the liquid crystal composition layer.

2. The manufacturing method for an optically anisotropic film according to claim 1,
wherein in the step 2, the irradiation direction of the ultraviolet ray is 5° to 85° with respect to a normal direction of the surface of the photo-alignment composition layer.

3. The manufacturing method for an optically anisotropic film according to claim 1,
wherein the polymerizable liquid crystal compound is a rod-like liquid crystal compound having three or more benzene rings.

4. The manufacturing method for an optically anisotropic film according to claim 1,
wherein in the step 4, a magnetic flux density of the magnetic field is 0.2 to 1.0 T.

5. The manufacturing method for an optically anisotropic film according to claim 2,
wherein the polymerizable liquid crystal compound is a rod-like liquid crystal compound having three or more benzene rings.

6. The manufacturing method for an optically anisotropic film according to claim 2,
wherein in the step 4, a magnetic flux density of the magnetic field is 0.2 to 1.0 T.

7. The manufacturing method for an optically anisotropic film according to claim 3,
wherein in the step 4, a magnetic flux density of the magnetic field is 0.2 to 1.0 T.
